(19) United States
(12) Patent Application Publication
(10) Pub. No.: US 2013/0016495 A1
(43) Pub. Date: Jan. 17, 2013

(54) STRUCTURE OF CANDLE HOLDER

(71) Applicant: SHENG-SHUI LEE, Xinfeng Township (TW)

(72) Inventor: SHENG-SHUI LEE, Xinfeng Township (TW)

(21) Appl. No.: 13/183,459

(22) Filed: Jul. 15, 2011

(51) Int. Cl. F21V 33/00; F21V 11/00

(52) U.S. Cl. 362/86; 362/311.02

(57) ABSTRACT

A candle holder includes a main body having a top opening and receiving therein a candle having a wick. The main body has an outer surface to which an optic fiber fabric is attached. The optic fiber fabric includes a base plate and a woven sheet of optic fibers that is connected to a controller and an LED lamp. The LED lamp emits a light source that makes the woven sheet of optic fibers giving off light on a whole surface thereof or dazzling or flashing of light, whereby the candle holder, besides the candle light, provides an additional function of showing a bright and sparkling appearance to improve the practical use thereof.

### (a) TECHNICAL FIELD OF THE INVENTION

The present invention generally relates to an improved structure of arbitrarily-shaped candle holder, which, besides the basic function of lighting with candle flame, provides an additional function of dazzling shining appearance to improve the practical use thereof

### (b) DESCRIPTION OF THE PRIOR ART

A conventional candle holder is illustrated in FIG. 1 of the attached drawings, which has a simple structure comprising a main body (10) that has a top opening and is light transmitting and receives therein a light-transmitting candle (20). The candle (20) comprises a wick (21), which has an upper end exposed outside a top face of the candle (20) for burning. After being lit, the candle makes a flame that gives off light. The light may transmit through the candle (20), making the circumference of the main body (10) also emitting light, which results in a sparkling and dazzling effect of the candle holder. Although this structure of candle holder makes a significant progress over the traditional candle holder for providing a more shining lighting effect, yet the lighting effect all comes from the flame light emitting from the burning wick, which is quite static and monotonous, making it hard to provide dynamic variation. Consequently, the shining effect is not good enough. The present invention thus aims to provide an improved structure of candle holder that overcomes such a problem.

### SUMMARY OF THE INVENTION

An objective of the present invention is to provide a candle holder that, besides the flame light generated by the candle itself, provides static or dynamic dazzling or flashing light through a main body of the candle holder, whereby thought a combination of the two types of light, the lighting generated by the candle holder is made more dazzling and brighter.

Another objective of the present invention is to provide a candle holder, wherein even through the candle is not set in fire and burning, the main body of the candle holder may be operated to give off static or dynamic dazzling or flashing of light to make the candle holder versatile in use.

To achieve the above objective, the present invention provides a candle holder that comprises a main body having a top opening and receiving therein a candle having a wick. The main body has an outer surface to which an optic fiber fabric is attached. The optic fiber fabric comprises a base plate and a woven sheet of optic fibers that is connected to a controller and an LED lamp. The LED lamp emits a light source that makes the woven sheet of optic fibers giving off light on a whole surface thereof or dazzling or flashing of light, whereby the candle holder, besides the candle light, provides an additional function of showing a bright and sparkling appearance to improve the practical use thereof.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional candle holder.

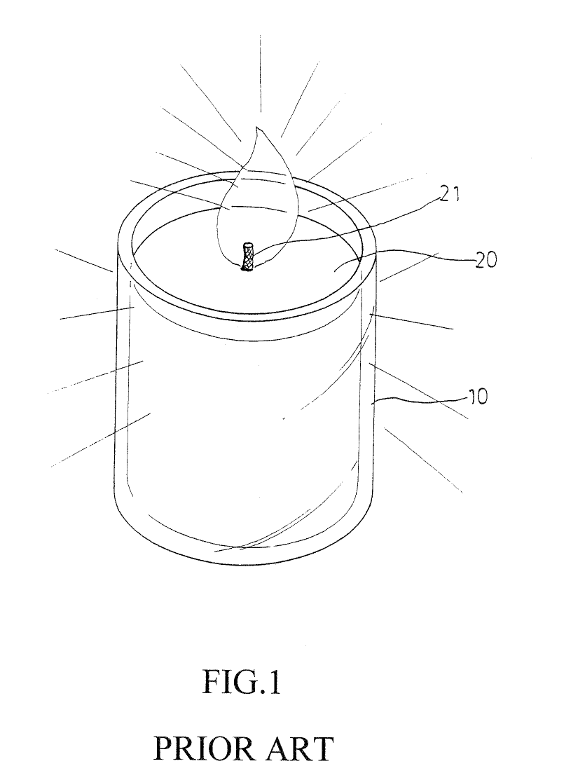

FIG. 2 is a perspective view of a candle holder in accordance with the present invention taken from a front side.

FIG. 3 is a perspective view of the candle holder in accordance with the present invention taken from a rear side.

FIG. 4 is a perspective view of the candle holder of the present invention, showing the candle holder in a partially exploded form.

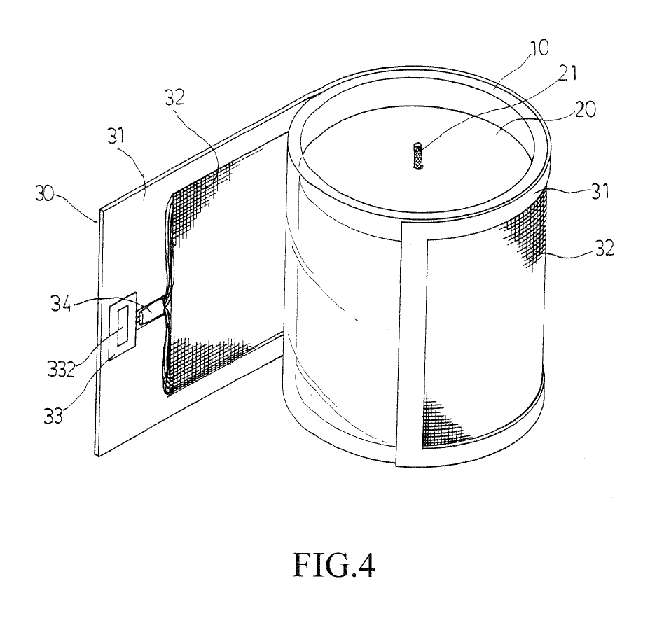

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

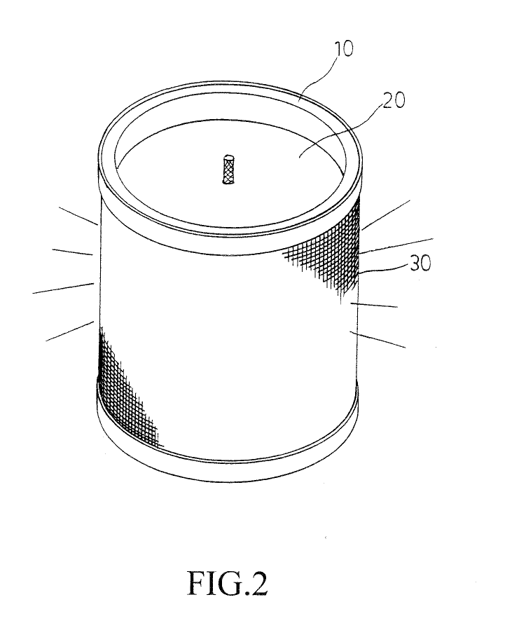

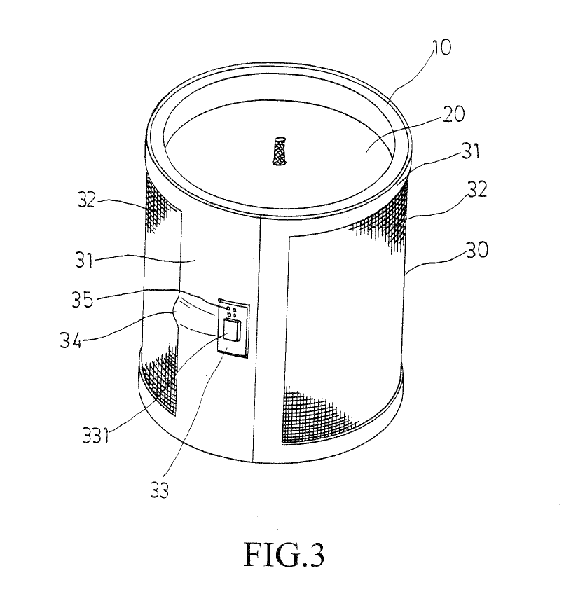

As shown in FIGS. 2 and 3, the present invention provides an improved structure of candle holder, which comprises a main body (10), a candle (20), and a piece of optic fiber fabric (30). The main body (10), which is preferably light transmitting, is structured to show an arbitrary shape having a top opening. The candle (20), which is preferably made light-transmitting, is received in the main body (10), preferably by pouring wax, paraffin or similar materials therein, and comprises a wick (21) having an upper end exposed outside a top face of the candle (20). The optic fiber fabric (30) is wrapped around an outer surface of the main body (10) and is composed of a base plate (31) that has a predetermined stiffness and a light-transmittable woven sheet of optic fiber (32). The base plate (31) forms a hollow section that has a large area and the optic fiber woven sheet (32) is received and retained inside the hollow section, preferably completely covering the hollow section. The base plate (31) also carries a controller (33). The controller (33) comprises a manual switch (331) and a sound generator (35) that are located at one side of the controller and a sensor (332) that is located at an opposite side. The controller (33) contains a cell or battery (not shown) therein. The controller (33) is connected through an electrical circuit to an LED (Light-Emitting Diode) lamp (34). All or some of the optic fibers that make the optic fiber woven sheet (32) have ends surrounding a light emission terminal of the LED lamp (34).

With the previously described arrangement, when the candle wick (21) is set in fire and burning, the light of the candle flame transmits through the candle (20) and the main body (10) and irradiates the sensor (332), which activates the LED lamp (34). The light emitting from the LED lamp (34) is spread over the whole surface of the optic fiber woven sheet (32). Thus, besides the flaming light generated by the burning candle wick (21), the candle holder also generates dazzling light in either static or dynamic form through the main body (10), whereby the lighting provided by the candle holder is improved and made brighter and more dazzling through combination of the light emitting from the optic fiber woven sheet (32) and the candle light generated by the burning wick (21).

In addition, even the wick (21) of the candle holder is no set in fire and burning, the main body (10) may be independently powered on through an operation of the manual switch (331) to activate the LED lamp (34), and can be switched between static dazzling or flashing or dynamic dazzling or flashing through another operation of the manual switch (331). This makes the candle holder versatile in use.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A candle holder, comprising a main body having a top opening and receiving therein a candle having a wick, the improvement comprising that the main body has an outer surface to which an optic fiber fabric is attached, the optic fiber fabric comprising a base plate and a woven sheet of optic fibers that is connected to a controller and an LED lamp.

2. The candle holder according to claim 1, wherein the base plate of the optic fiber fabric forms a hollow section in which the woven sheet of optic fibers is received and retained, the controller being mounted to the base plate and electrically connected to the LED lamp, the optic fibers of the woven sheet having ends surrounding a light source terminal of the LED lamp.

3. The candle holder according to claim 1, wherein the controller has one side to which a manual switch is mounted.

4. The candle holder according to claim 1, wherein the controller has one side to which a sensor is mounted.

5. The candle holder according to claim 1, wherein the controller comprises a sound generator.

6. The candle holder according to claim 1, wherein the main body is structured to show an arbitrary shape having the top opening.

7. A candle holder comprising a main body having a top opening and receiving therein a candle having a wick, the improvement comprising that the main body has an inner surface to which an optic fiber fabric is attached, the optic fiber fabric comprising a base plate and a woven sheet of optic fibers that is connected to a controller and an LED lamp.
